(19) United States
(12) Patent Application Publication
(10) Pub. No.: US 2007/0175885 A1
(43) Pub. Date: Aug. 2, 2007

(54) Modular steam oven construction method and related double cavity steam oven assembly

(76) Inventors: David C. Brower, Beavercreek, OH (US); Richard E. Chitwood, Troy, OH (US); Alva R. Clark JR., Troy, OH (US); Lowell W. Doss, Vandalia, OH (US); Jeffrey L. Frock, Troy, OH (US); Larry W. Lyons, Hillsboro, OH (US); John E. Pleiman, Tipp City, OH (US); Daniel N. Puterbaugh, W. Milton, OH (US); Michael B. Reckner, Dayton, OH (US); Atul Saksena, Troy, OH (US)

Correspondence Address: THOMPSON HINE LLP;Intellectual Property Group, P.O Box 8801, DAYTON, OH, 45401-8801, US

(21) Appl. No.: 11/341,061

(22) Filed: Jan. 27, 2006

(51) Int. Cl. A21B 1/22

(52) U.S. Cl. 219/401

(57) ABSTRACT

A steam oven construction and method of assembly utilizing a modular cavity unit is described.

### TECHNICAL FIELD

This application relates generally to steam ovens for steaming food products and, more specifically, to a modularized method of constructing steam ovens of various configurations.

### BACKGROUND

Steam cookers have been successfully employed by schools, restaurants, hospitals, universities and other food service operations to prepare quickly and conveniently large quantities of food. Different food service operations have different needs and therefore steam ovens are available in a variety of sizes and capacities. For example, it is known to provide steam ovens with a single steam cavity. It is also known to provide steam ovens with two steam cavities, one arranged above the other. Steam oven manufacturers therefore have a need to be flexible in terms of product offerings. Accordingly, it would be desirable to provide a steam oven cavity unit and method of steam oven construction that is adaptable to build out of different oven assemblies depending upon orders received from customers.

### SUMMARY

In one aspect, a method of manufacturing and filling orders for a series of single and double cavity steam ovens is provided. Each oven includes at least one modular cavity unit. The modular cavity unit includes a substantially box-shaped cooking cavity defined by left, right, top, bottom and rear walls and a front access opening. A front panel is adjacent the front access opening and has one or more control panel openings located to one side of the opening. The modular cavity unit has an upper stacking feature and a lower stacking feature. The method includes the steps of:

(a) building a plurality of modular cavity units;

(b) if filling an order for a single cavity oven,
(1) selecting one modular cavity unit and with respect to such modular cavity unit:
   (i) placing a top oven panel above the insulation adjacent the top cavity wall;
   (ii) placing single cavity height left and right oven side panels on left and right sides of the modular cavity unit;
(2) shipping the single cavity oven subsequent to step (b)(1);

(c) if filling an order for a double cavity oven,
(1) placing a first modular cavity unit atop a second modular cavity unit such that the lower stacking feature of the first modular cavity unit interacts with the upper stacking feature of the second modular cavity unit;
(2) placing a top oven panel above the insulation adjacent the top cavity wall of the first modular cavity unit;
(3) placing double cavity height left and right oven side panels on left and right sides of the stacked first and second modular cavity units;
(4) shipping the double cavity oven subsequent to steps (c)(1), (c)(2) and (c)(3).

In another aspect, a double cavity steam oven assembly includes a first cavity unit and a second cavity unit. The first cavity unit includes a cooking cavity defined by left, right, top, bottom and rear walls and a front access opening. A front panel adjacent the front access opening has one or more controls thereon. The first cavity unit includes a lower stacking feature in the form of a lower, rearwardly extending lip. A second cavity unit includes a cooking cavity defined by left, right, top, bottom and rear walls and a front access opening, with a front panel adjacent the front access opening and having one or more controls thereon. The second cavity unit includes an upper stacking feature in the form of an upper, rearwardly extending lip. The first cavity unit is stacked atop the second cavity unit with the lower lip for the first cavity unit aligned with and resting on the upper lip of the second cavity unit. A steam generator is plumbed to deliver steam to both the first cooking cavity and the second cooking cavity.

### BRIEF DESCRIPTION OF THE DRAWINGS

FIG. 1 is perspective view of one embodiment of a double cavity oven assembly;

FIG. 2 is a perspective view of one embodiment of a modular cavity unit;

FIG. 3 a cross-section along line 3-3 of FIG. 2;

FIG. 4 is a cross-section along line 4-4 of FIG. 2;

FIG. 5 is a cross-section along line 5-5 of FIG. 3;

FIG. 6 is a partial rear perspective of the modular cavity unit of FIG. 2;

FIG. 7 is a schematic partial cross-section along line 7-7 of FIG. 1;

FIG. 8 is a schematic partial cross-section of the upper portion of a single cavity oven assembly;

FIG. 9 depicts an exemplary manufacturing process for selectively producing either single cavity or double cavity oven assemblies using modular cavity units.

### DETAILED DESCRIPTION

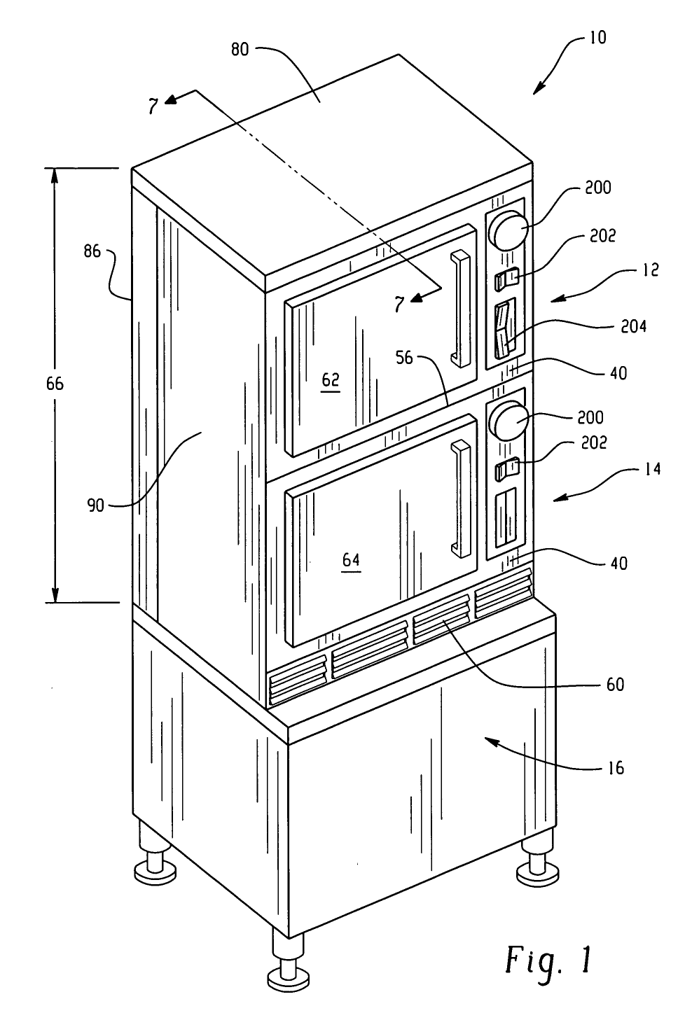

Referring to FIG. 1, a double cavity steam oven assembly 10 is shown. The assembly 10 includes an upper cavity unit 12, a lower cavity unit 14 and a steam generator base 16. In one method of construction, each cavity unit 12 and 14 is initially formed as a modular cavity unit that is available for use in forming either a single cavity steam oven assembly or a double cavity steam oven assembly.

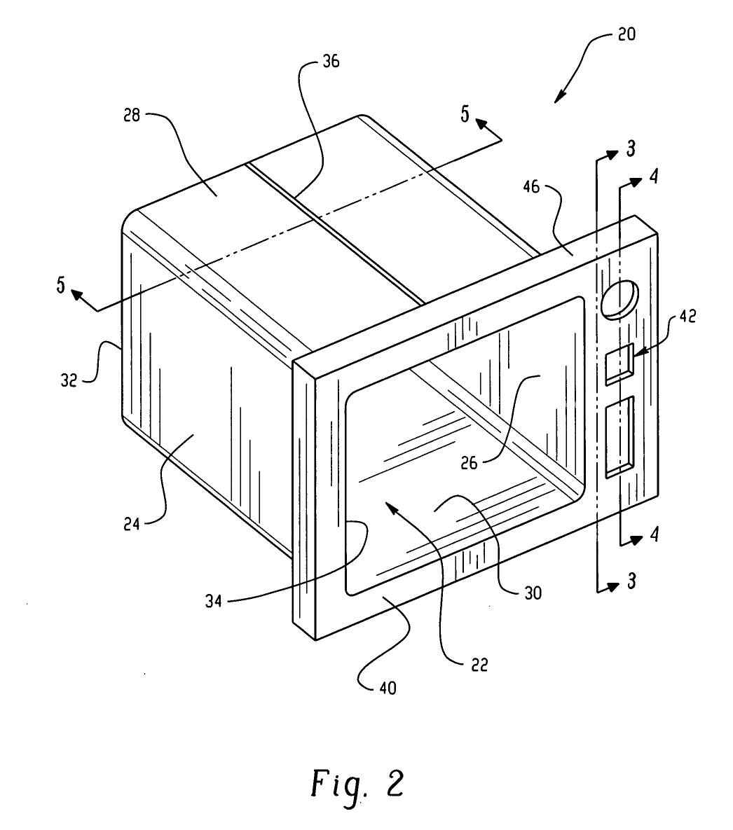

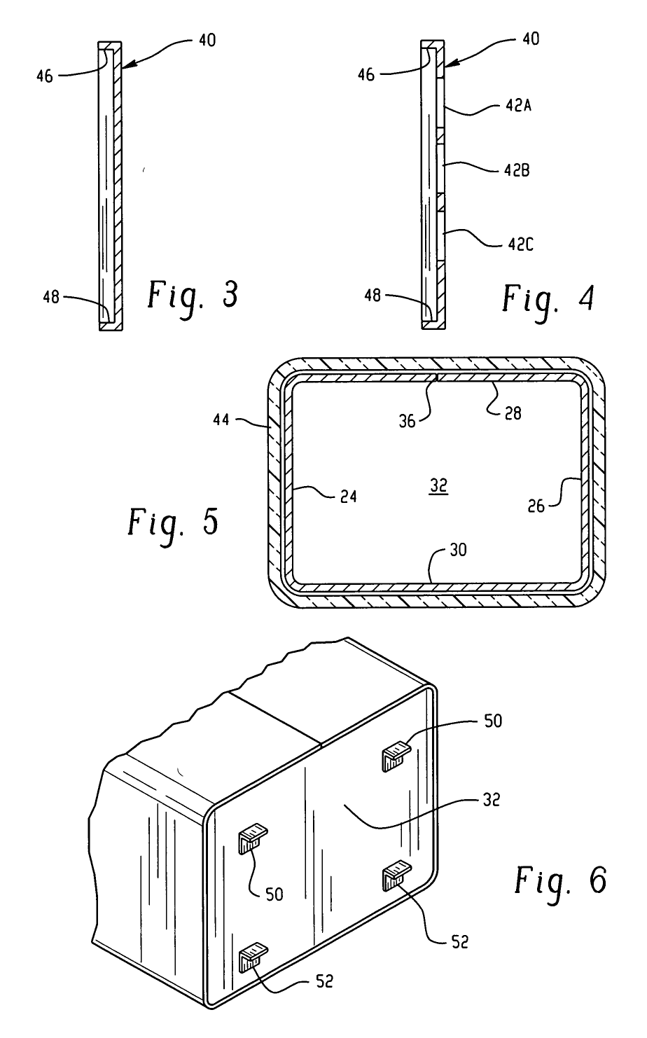

Referring now to FIGS. 2-6, in one example the modular cavity units 20 may be formed to include a substantially box-shaped cooking cavity 22 defined by left 24, right 26, top 28, bottom 30 and rear 32 walls and a front access opening 34. The cavity walls 24, 26, 28 and 30 may be formed by bending a sheet of stainless steel and welding abutting ends of the stainless steel at a weld joint 36 located along the top wall 28. The rear wall 32 may be formed of a panel that is welded on after the left, right, top and bottom walls are formed. Alternatively, rear cavity wall 32 may be formed by bending and welding a rearwardly extending flap or flaps of one or more of cavity walls 24, 26, 28 and 30. A front, generally rectangular panel 40 frames the front access opening 34 and has one or more control panel openings 42 located to one side of the opening. Insulation 44 (not shown in FIG. 2, but shown in FIG. 5) is located adjacent exterior sides of the left 24, right 26, top 28, bottom 30 and rear 32 cooking cavity walls. The insulation 44 may be foil backed insulation or some other suitable form. As shown, the front panel 40 is provided with upper and lower stacking features in the form of rearwardly extending upper and lower lips 46 and 48. Similar lips may also be provided on the left and right sides of the front panel for structural integrity. The lips 46, 48 may be continuous, extending substantially the entire width of the front panel. Alternatively the lips 46, 48 could be formed in an intermittent manner, or other types of stacking features (e.g., brackets, upper holes and lower posts, etc.) could be provided. While the front panel frames the opening, the front panel could be simply to one side of the opening, in which case the lips 46, 48 could be formed in part by bends unitary with the panel and in part by bends unitary with the top and bottom cavity walls.

As best seen in FIG. 4 the control panel openings 42 may include a timer opening 42A, a cook/ready indicator opening 42B and a steam generator control switch opening 42C. Referring to FIG. 6, the exterior of the rear cavity wall is shown (without insulation) and includes spaced apart upper 50 and lower mounts 52 extending rearwardly therefrom, the purpose of which will be described in further detail below. The mounts may take the form of studs, L-shaped brackets or other protrusions that may be welded to the exterior side of rear cavity wall 32.

Referring back to FIG. 1, the oven assembly 10 is constructed such that cavity unit 12 is stacked atop cavity unit 14, with the lower lip of the front panel 40 of upper cavity unit 12 aligned with and resting upon the upper lip of the front panel 40 of lower cavity unit 14. A sealant may be provided along the joint or interface 56 if desired. A louvered front panel 60 is located beneath the lower cavity unit 14 and may also include a rearwardly extending lip upon which the lower lip of the front panel 40 of the cavity unit 14 rests. The louvered panel may have frame members extending rearwardly therefrom for support. The base 16 houses a steam generator which may take the form of a water tank including a heat exchanger. Both electrical and gas-fired steam generator constructions are contemplated. Respective access doors 62 and 64 of the upper and lower cavities are also shown.

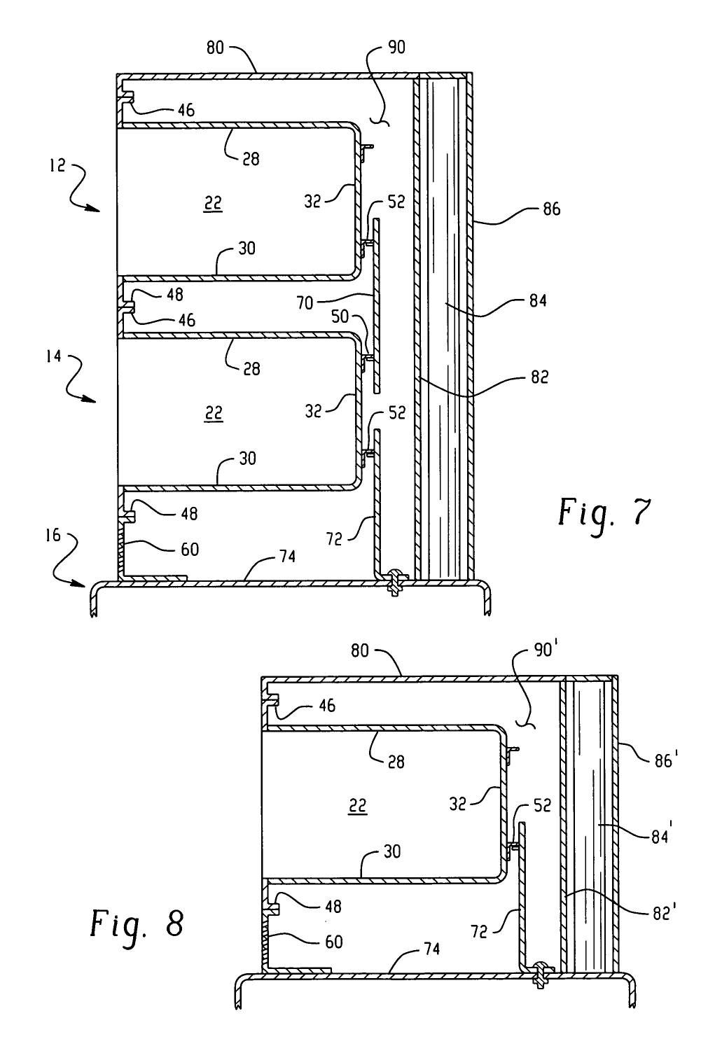

FIG. 7 shows a schematic partial cross-section of the upper portion 66 of the double cavity oven assembly 10 of FIG. 1, with lower lip 48 of upper cavity unit 12 resting atop upper lip 46 of lower cavity unit 14. The doors of the cavity units are not shown in FIG. 7. Support members 70 extend between the lower mounts 52 of the upper cavity unit 12 and the upper mounts 50 of the lower cavity unit 14 to support the to hold the rear portion of the upper cavity unit 12 above the lower cavity unit 14. Lower, L-shaped supports 72 extend between the lower mounts 52 of the lower cavity unit 14 and the upper portion 74 of the steam generator base 16 to support the rear portion of the lower cavity unit 14 above the base 16 (which is only partially shown). The supports 70 and 72 may take any suitable form, including metal straps, rods or brackets. The supports 70 and 72 may be connected to the mounts and/or base portion 74 via suitable fasteners, welding or other means. Likewise, the louvered panel 60 may be suitably mounted to the upper portion 74 of the base to provide forward support for the cavity units. Top trim panel 80 extends rearward from the front panel of the upper cavity unit 12 to an interior support panel 82 and may includes a front lip resting on upper lip 46 of the upper cavity unit 12. Rearward of the support panel 82 a space is provided for a combustion gas exhaust flue 84 (in the case of gas-fired steam generators). A rear, exterior trim panel 86 (also functioning as a heat shield) covers the exhaust flue space.

Referring again to FIG. 1, as shown the double cavity oven assembly 10 includes left and right exterior panels 90 (left only shown) that have a double cavity height (i.e. a single unitary panel extends for substantially the entire height of both cavity units combined). Likewise, the rear panel 86 has a double cavity height.

FIG. 8 shows a schematic cross-section similar to that of FIG. 7, but for a single cavity oven assembly. As shown, the louvered base 60, support 72 and top panel 80 are of common construction as between the singe cavity and double cavity oven assemblies. The side panels 90′, rear support panel 82′, exhaust stack 84′ and rear trim panel/heat shield 86′ all have a shorter, single cavity height as compared to the double cavity height of components 90, 82, 84 and 86 of the double cavity oven.

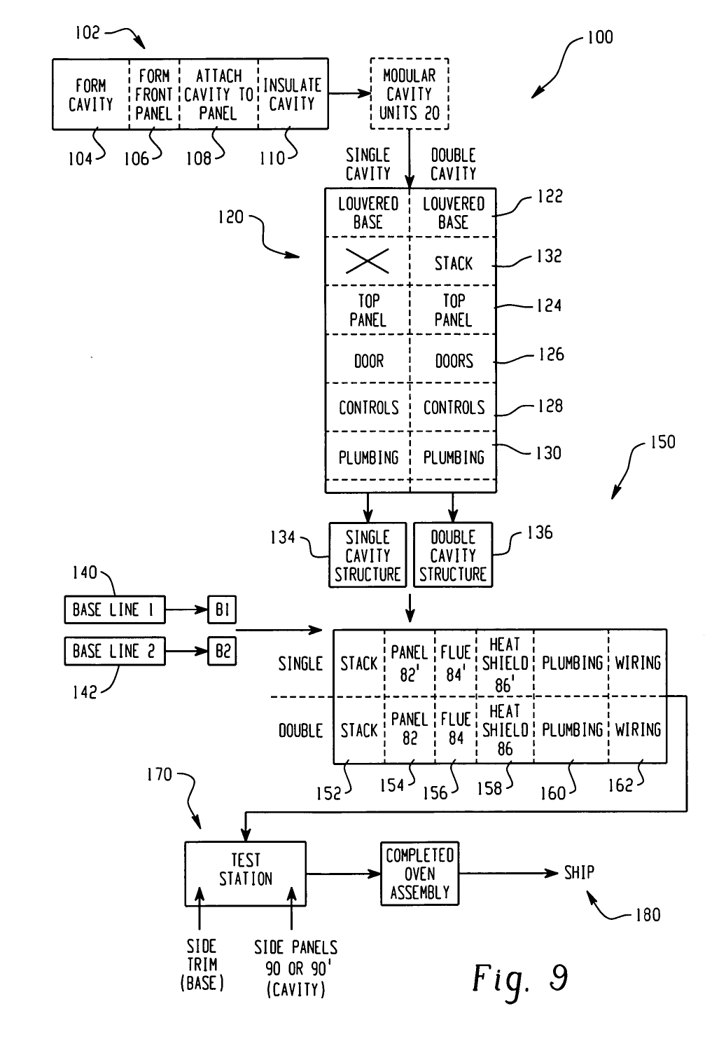

Referring now to FIG. 9, an exemplary manufacturing process 100 for constructing either single cavity or double cavity steam oven assemblies utilizing a modular cavity unit (such as 20 shown in FIGS. 2-6) is shown.

A modular unit construction process 102 includes forming the cavity 104, forming the front panel 106, attaching the cavity to the front panel 108 and insulating the cavity 110. Cavity formation 104 may include (i) bending a stainless steel sheet to form the left, right, top and bottom sides and welding the joint 36, (ii) welding the rear wall to the left, right, top and bottom walls, (iii) attaching the mounts 50 and 52 to the exterior side of the rear wall and (iv) providing one or more openings in one or more of the cavity walls for the ingress/egress of steam. Front panel formation 106 may include (i) creating an opening (as by cutting or stamping) for the cavity from a stainless steel sheet, (ii) creating the control panel openings 42 (as by cutting or stamping), (iii) applying an adhesive control panel overlay in the vicinity of the openings 42, (iv) bending side portions of the stainless steel sheet to form the upper, lower and side lips and (v) welding the corner seams between the upper lip and side lips and welding the corner seams between the lower lip and side lips. Attaching 108 the cavity to the front panel may be completed via a welding process. Insulating 110 the cavity may be achieved by wrapping the left, right, top, bottom and rear cavity walls with a foil backed insulation and taping insulation joints using a foil tape. In an alternative embodiment, the cavities may be insulated during a later assembly step, as for example just before the plumbing 130 is installed

Based upon an order received from a customer, the modular units 20 may be used to assemble either a single cavity oven assembly or a double cavity oven assembly. An upper oven portion assembly process 120 is shown for both single and double cavity ovens. Both processes include louvered base installation 122, top panel installation 124, door installation 126, controls installation 128 and partial plumbing installation 130. Louvered base installation 122 may include (i) attaching (as by fasteners) the lower lip of the lower cavity unit (or single cavity) to an upper lip of the louvered panel 60 base and (ii) attaching the lower supports 72 to the lower mounts 52 of the lower cavity unit (or single cavity). Top panel installation may include utilizing fasteners to connect the upper lip of the upper cavity unit (or single cavity) to a lower lip formed on the top panel 80. Door installation 126 may include pivotally connecting a door, or doors in the case of double cavity ovens. Controls installation 128 may, in the case of a single cavity oven assembly, include (i) incorporating a timer element 200 into opening 42A, (ii) incorporating a ready/cook light indicator 202 into opening 42B and (iii) incorporating a steam generator control switch 204 into opening 42C. Controls installation 128 may, in the case of a double cavity oven assembly, include (i) incorporating a timer element 200 into both openings 42A, (ii) incorporating a ready/cook light indicator 202 into both openings 42B, (iii) incorporating a steam generator control switch 204 into the opening 42C of one cavity unit and (iv) incorporating a plastic insert or blank into the opening 42C of the other cavity unit, as generally only a single steam generator control is needed. Plumbing installation 130 may, in the case of a single cavity oven assembly, include running a steam input line, including a steam input control valve (e.g., solenoid type) from a steam inlet opening of the cavity. Plumbing installation 130 may, in the case of a double cavity oven assembly, include running two steam input lines, including respective steam input control valves (e.g., solenoid type) from corresponding steam inlet openings of the cavities. As seen in FIG. 9, in the case of double cavity oven assemblies the process 120 also includes stacking 132 one modular cavity unit atop another modular cavity unit, which may involve connecting the upper and lower lips of the front panels of the respective cavity units in a suitable manner and installing the supports 70. Single cavity structures 134 or double cavity structures 136, which can thereafter be connected to a generator base, result from process 120.

FIG. 9 shows two different base forming processes 140 and 142, one for producing electrically powered steam generator bases B1 and one for producing gas-powered generator bases B2. The details of base production need not be provided, suffice it to say that each base B1 and B2 includes a steam supply line, a drain line and electrical connections for connecting to the controls of the structure 134 or 136.

In process 150 the units 134, 136 are combined with a steam generator base B1 or B2. Specifically, the structures are stacked 152 atop the base. Rear structural panels 82 or 82′ are installed at step 154. Flues 84 or 84′ are installed (in the case of gas-powered bases B2) at step 156. Heat shields 86 or 86′ are installed at step 158. The steam generator is plumbed 160 to deliver steam to the cavity or cavities and the wiring 162 of the oven assemblies is completed. Stacking 152 may include attaching the louvered base 60 and supports 72 to the upper portion 74 of the steam generator base 16. Panel installation 154 may utilize fasteners, snap-fit or other suitable means. Flue installation 156 includes connecting the exhaust path of the base to the flue 84 or 84′ and securing the flue in place. Plumbing installation 160 may include connecting the steam output line of the base to the steam inlet control valve (or valves in the case of double cavity assemblies) of the cavity or cavities, as well as connecting steam outlet(s) of the cavity or cavities of the cavity or cavities to the drain line of the steam generator base. In the case, of double cavity ovens each cavity is plumbed to receive steam from a single, common steam output line of the steam generator base, and is plumbed such that steam from the cavity outlets is delivered back to a common drain line/path of the steam generator base. Wiring installation 162 involves connecting all controls and controlled components as necessary for proper oven operation.

The assembled oven (less side trim) can then be moved to a test station 170 where various test operations are performed for quality control. Once testing is completed, the base side trim panels can be installed and the cavity side trim panels 90 or 90′ can be installed. The completed oven can then be shipped 180 to the ordering customer.

Respective processes 102, 120, 140, 142, 150 and 170 can be performed at different manufacturing lines or zones of a common manufacturing plant. Alternatively, some of the processes may be performed at different sites. Moreover, various steps may be performed in different orders.

It is to be clearly understood that the above description is intended by way of illustration and example only, is not intended to be taken by way of limitation, and that various changes and modifications are possible. For example, while the modular cavity units are described as being formed without doors and without installed controls, it is contemplated that such components could be installed as part of the modular unit construction process 102. Other variations are possible as well.

What is claimed is:

1. A method of manufacturing and filling orders for a series of single and double cavity steam ovens, each oven comprising at least one modular cavity unit comprising,
a substantially box-shaped cooking cavity defined by left, right, top, bottom and rear walls and a front access opening, a front panel adjacent the front access opening and having one or more control panel openings located to one side of the opening, the modular cavity unit having an upper stacking feature and a lower stacking feature,
the method comprising the steps of
(a) building a plurality of modular cavity units,
(b) if filling an order for a single cavity oven,
(1) selecting one modular cavity unit and with respect to such modular cavity unit:
(i) placing a top oven panel above the insulation adjacent the top cavity wall;
(ii) placing single cavity height left and right oven side panels on left and right sides of the modular cavity unit;
(2) shipping the single cavity oven subsequent to step (b)(1);
(c) if filling an order for a double cavity oven,
(1) placing a first modular cavity unit atop a second modular cavity unit such that the lower stacking feature of the first modular cavity unit interacts with the upper stacking feature of the second modular cavity unit;
(2) placing a top oven panel above the insulation adjacent the top cavity wall of the first modular cavity unit;
(3) placing double cavity height left and right oven side panels on left and right sides of the stacked first and second modular cavity units;
(4) shipping the double cavity oven subsequent to steps (c)(1), (c)(2) and (c)(3).

2. The method of claim 1 wherein the modular cavity unit lacks any installed controls, and:
step (b)(1) includes installing one or more controls behind the front panel with one or more corresponding actuators or indicators positioned in the one or more control panel openings;
prior to step (c)(4) step (c) includes installing one or more controls behind the front panel of the first modular cavity unit with one or more corresponding actuators or indicators position in the one or more control panel openings of the first modular cavity unit and installing one or more controls behind the front panel of the second modular cavity unit with one or more corresponding actuators position in the one or more control panel openings of the second modular cavity unit.

3. The method of claim 1 wherein a first manufacturing line or zone is provided for step (a), a second, common manufacturing line or zone is provided for performing steps (b)(1)(i), (c)(1), and (c)(2).

4. The method of claim 3 wherein steps (b)(1)(ii) and (c)(3) are performed at a common manufacturing station.

5. The method of claim 4 wherein the common manufacturing station comprises a test station.

6. The method of claim 1 wherein:
step (b)(1) includes the step of installing at least partial plumbing for delivering steam to the cavity of the selected modular cavity unit, and
prior to step (c)(4) step (c) includes the step of installing at least partial plumbing for delivering steam to the cavity of the first modular cavity unit and to the cavity of the second modular cavity unit.

7. The method of claim 6 wherein prior to step (c)(4) step (c) includes plumbing the first and second modular cavity units to receive steam from a common source and plumbing the first and second modular cavity units to output steam to a common outlet.

8. The method of claim 6 wherein:
step (b)(1) includes the step of installing a door on the selected modular cavity unit, and
prior to step (c)(4) step (c) includes the step of installing a first door on the first modular cavity unit and installing a second door on the second modular cavity unit.

9. The method of claim 1 wherein:
step (b) includes the step of stacking the selected modular cavity unit atop a steam generator base prior to step (b)(2),
step (c) includes the step of stacking the stacked first and second modular cavity units atop a steam generator base prior to step (c)(4).

10. The method of claim 9 wherein a first manufacturing line or zone is provided for step (a), a second manufacturing line or zone is provided for performing steps (b)(1)(i), (c)(1) and (c)(2), a third manufacturing line or zone is provided for performing the stacking operations atop steam generators.

11. The method of claim 10 wherein in step (b) includes, in the third manufacturing line or zone, connecting the plumbing of the steam generator to deliver steam to the selected modular cavity unit, step (c) includes, in the third manufacturing line or zone, connecting the plumbing of the steam generator to deliver steam to the selected modular cavity unit.

12. The method of claim 1 wherein each modular cavity unit has insulation placed around the top, bottom, left, right and rear walls.

13. A double cavity steam oven assembly, comprising:
a first cavity unit including a cooking cavity defined by left, right, top, bottom and rear walls and a front access opening, a front panel adjacent the front access opening and having one or more controls thereon, the first cavity unit including a lower stacking feature;
a second cavity unit including a cooking cavity defined by left, right, top, bottom and rear walls and a front access opening, a front panel adjacent the front access opening and having one or more controls thereon, the second cavity unit including an upper stacking feature, the first cavity unit stacked atop the second cavity unit with the lower stacking feature of the first cavity unit aligned with and engaging the upper stacking feature of the second cavity unit;
a steam generator plumbed to deliver steam to both the first cooking cavity and the second cooking cavity.

14. The double cavity steam oven assembly of claim 13 wherein the lower stacking feature takes the form of a lower lip extending rearwardly from the front panel of the first cavity unit, the upper stacking feature takes the form of an upper lip extending rearwardly from the front panel of the second cavity unit, the lower lip rests atop the upper lip.

15. The double cavity steam oven assembly of claim 13 wherein the first and second cavity units are stacked atop a base that incorporates the steam generator.

16. The double cavity steam oven assembly of claim 13, further comprising:
double cavity height left and right exterior side panels on left and right sides of the stacked first and second cavity units.

17. The double cavity steam oven assembly of claim 14, further comprising:
first and second spaced apart mounts extending from the exterior of a lower portion of the rear wall of the first cavity unit;
third and fourth spaced apart mounts extending from the exterior of an upper portion of the rear wall of the second cavity unit;
a first support member extending between the first mount and the third mount, a second support member extending between the second mount and the fourth mount, the first and second support members holding the rear portion of the first cavity unit above the second cavity unit.

18. The double cavity steam oven assembly of claim 17 wherein the first and second cavity units are stacked atop a base that incorporates the steam generator, a lower portion of the rear wall of the second cavity unit includes at least a fifth mount extending therefrom, and an L-shaped support extends from the fifth mount to an upper portion of the base to support the rear portion of the second cavity unit above the base.

19. The double cavity steam oven assembly of claim 14 wherein the lower lip of the first cavity unit spans substantially the entire width of the first cavity unit, the upper lip of the second cavity unit spans substantially the entire width of the second cavity unit.

20. The double cavity steam oven assembly of claim 19 wherein a sealant is applied at the interface between the lower lip and the upper lip.

21. The double cavity steam oven assembly of claim 14 wherein the front panel of the first cavity unit includes an upper stacking feature in the form of an upper lip extending rearwardly therefrom and the second cavity unit includes a lower stacking feature in the form of a lower lip extending rearwardly therefrom.

22. The double cavity steam oven assembly of claim 21 wherein a top exterior panel of the oven assembly includes a lower lip resting upon the upper lip of the first cavity unit, and a louvered base panel of the oven assembly includes an upper lip upon which the lower lip of the second cavity unit rests.

23. The double cavity steam oven assembly of claim 13 wherein the front panel of the first cavity unit frames the front access opening of the cooking cavity of the first cavity unit, the front panel of the second cavity unit frames the front access opening of the cooking cavity of the second cavity unit.
